(19) United States
(12) Patent Application Publication
(10) Pub. No.: US 2010/0215818 A1
(43) Pub. Date: Aug. 26, 2010

(54) INSTANT DRINK POWDER

(75) Inventors: Ulrich Kessler, Savigny (CH); Jean-Louis Duffey, Lugrin (FR); Marc Georges Dreyer, Chernex (CH); Michael Desmond Kauter, Queensland (AU); Mathalai Balan Sudharsan, Lausanne (CH); Helene Michele Jeanne Chanvrier, Epinal (FR); Olaf Wehrspann, Orbe (CH); Xiaoping Fu, Dublin, OH (US)

Correspondence Address: K&L Gates LLP, P.O. Box 1135, CHICAGO, IL, 60690, US

(73) Assignee: NESTEC S.A., Vevey (CH)

(21) Appl. No.: 12/680,671

(22) PCT Filed: Sep. 10, 2008
(86) PCT No.: PCT/EP2008/061971

§ 371 Date: Mar. 29, 2010

Related U.S. Application Data
(60) Provisional application No. 60/976,229, filed on Sep. 28, 2007.

(51) Int. Cl. A23F 5/36; A23F 5/28; A23F 5/14

(52) U.S. Cl. 426/329; 426/590; 426/594; 426/588; 426/470; 426/569

(57) ABSTRACT

The present invention relates to an instant drink powder, preferably an instant coffee powder, which upon reconstitution provides improved foaming. The powder comprises particles having a porosity of at least 55%. The present invention also relates to the use of such a powder, as well as to the method of manufacturing said powder.

### FIELD OF THE INVENTION

The present invention relates to an instant drink powder, preferably an instant coffee powder, which upon reconstitution provides improved foaming. The present invention also relates to the use of such a powder, as well as to the method of manufacturing said powder.

### BACKGROUND OF THE INVENTION

Numerous methods have been described to improve the foam formation on instant beverages. For instance WO 97/33482 relates to a soluble coffee beverage powder which comprises a gas containing soluble whitener powder and a soluble coffee powder. EP 0 154 192 B2 and GB 2 154 422 A describe a way to obtain a foaming beverage by adding water to a pulverant material having a protein/lactose weight ratio of ⅓ to ⅕ and comprising stabilising salts.

Foaming creamers are also disclosed in U.S. Pat. No. 4,438,147. A method for increasing the foaming capacity of spray-dried powders is given in EP 1 627 572 whereby amorphous particles of a powdered soluble composition having internal voids are filled with a gas. Another way to fill internal voids with pressurised gas in order to give a foaming soluble coffee powder is given in EP 1 627 568. Soluble coffee beverage having a foamed upper surface is described in U.S. Pat. No. 6,964,789.

Most of the prior art deals with beverages having a creamer component, which upon reconstitution provides the froth and foam desired. However, fewer citations relate to instant beverages which do not comprise a creamer component and which are yet foamy on the upper surface. Such a beverage composition is described in U.S. Pat. No. 5,882,717 and EP 0 839 457 for example. The reconstituted coffee beverage is said to have an improved in-cup foam which simulates the foam formed on espresso made from roasted and ground espresso coffee (called “crema”).

There is thus still room for improvement in the field of foamy instant beverages.

### OBJECT OF THE PRESENT INVENTION

It is therefore an object of the present invention to improve the stability and amount of foam produced when reconstituting an instant beverage powder.

### SUMMARY OF THE INVENTION

Accordingly, this need is solved by the features of the independent claims. The dependent claims further develop the central idea of the invention.

Thus, in a first aspect, the present invention relates to an instant drink powder comprising porous powder particles characterised in that the powder particles have a porosity of at least 65%, preferably at least 70%.

The use of a powder according to any of claims 1 to 5, for the preparation of an instant drink also forms part of the present invention.

A third aspect of the invention pertains to a method for the manufacture of an instant drink powder comprising the steps of:
a. Subjecting a instant drink extract to a pressure of 50 to 400 bar, preferably of 150 to 400 bar
b. Adding gas to the pressurised extract,
c. Spraying and drying the extract to form an instant drink powder,
   and to a product obtainable by said method.

### FIGURES

The present invention is further described hereinafter with reference to some of its embodiments shown in the accompanying drawings in which:

FIG. 1 illustrates the particle porosity of products according to the invention (PI I and PI II) and the particle porosity of prior art products (PA I, PA II and PA III),

FIG. 2 is a diagram showing average pore diameter (D₅₀) of the particle void space distribution and the span of same distribution ((D₉₀-D₁₀)/D₅₀)for products of the invention (PI I, PI II) and for prior art products (PA I, PA II, PA III),

FIG. 3 depicts the amount of crema as a function of porosity for products of the invention (PI I, PI II) and for prior art products (PA I, PA II, and PA III),

FIG. 4 is a sketch depicting a method for producing the powder of the invention,

FIG. 5 is a drawing of a device for measuring the amount of crema formed upon reconstitution of a beverage powder. The inner diameter of the reconstitution vessel is 71 mm, the inner height 77.5 mm, the height of the lid is 65 mm, and

FIG. 6 is two cross-sections of a layer of typical coffee particles of the invention at two different magnifications, obtained by X-ray tomography. The scale bars represents 500 microns (upper image) and 250 microns (lower image) respectively.

### DETAILED DESCRIPTION OF THE INVENTION

The present invention relates to instant drink compositions with improved crema. By “crema” is meant the fine foam formed on the surface of a liquid. Crema is for example observed upon extraction of roasted and ground coffee under high pressure with special coffee machines.

In the following description, reference is made to instant coffee compositions as a preferred embodiment.

The instant drink composition may however also be cocoa, chocolate, tea, soup, fruity drinks etc.

By instant drink composition is meant a dried, soluble powder composition which can be reconstituted by addition of a liquid, e.g. hot or cold water, milk, juice etc.

The instant coffee powder of the invention comprises porous powder particles which are characterised in that the powder particles have a porosity of at least 55%, preferably at least 65%, even more preferably at least 70%. In a preferred embodiment, the powder particle porosity is between 65 and 85%, more preferably between 65 and 80%, even more preferably between 70 and 80%, most preferably between 70 and 75%.

Porosity can be measured by means known in the art. For instance, the porosity can be measured by the following equation:

$$\frac{Vp - Vcm}{Vp} \times 100$$

wherein Vp is the volume of the particle and Vcm is the volume of the coffee matrix in the particle. These values may be determined by standard measurements such as mercury porosimetry or also by x-ray tomographyic technique.

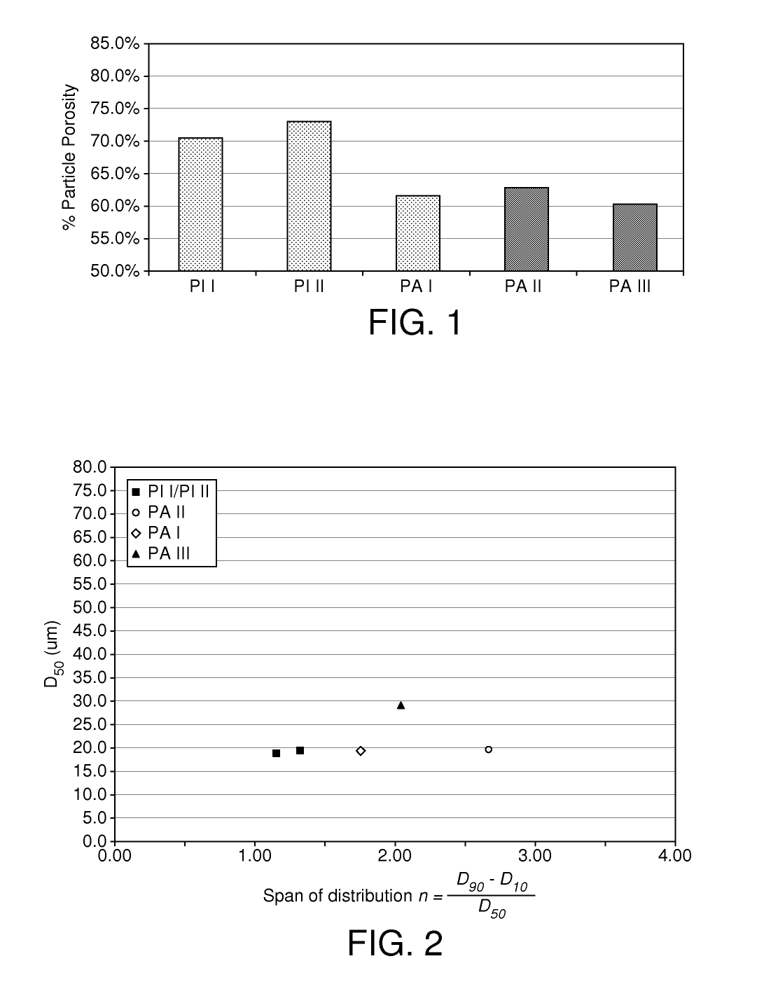

The powder of the invention is therefore characterised by its high porosity in comparison with known products (see FIG. 1). Not only does the high porosity contribute to the good solubility of the powder of the invention, but it also allows an increased amount of crema to be formed upon reconstitution of the powder.

The pores of the present powder may have an average diameter D₅₀ less than 80 microns, preferably less than 60 microns, more preferably less than 40 microns, most preferably less than 25 microns. The void space distribution in the particles is measured by X-ray tomography. The pore size characterising the present powder is larger than that described in U.S. Pat. No. 5,882,717. Surprisingly, however, it has been found that larger pore sizes still provide a fine and generous crema in the final reconstituted product.

The powder of the invention may also be characterised by the span of the void space distribution in the particle, which is obtained from X-ray tomography. The span of the distribution is calculated by the following equation:

$$Span = \frac{{D}_{90} - {D}_{10}}{{D}_{50}}$$

Wherein D₉₀, D₁₀ and D₅₀ represents the diameters where 90%, 10% and 50%, respectively, of the particle volume is in particles with a size below this value. Thus, a distribution span factor (n) of less than 4, preferably less than 3, more preferably less than 2, most preferably less than 1.5 characterises the pores of the powder according to the invention. The lower the span factor (n), the more uniform and sharp is the size distribution. Thus, the products of the invention are characterised by a sharper size distribution than the prior art products (cf. FIG. 2).

The particle size of the powder particles may e.g. be characterised by the median particle diameter (volume distribution), X₅₀. X₅₀ is preferably in the range between 50 and 500 microns, such as e.g. between 100 and 300 microns, or between 150 and 250 microns.

The advantages conferred by these characteristics upon the powders of the invention include increased crema and stability of the crema upon reconstitution of the powder in a liquid.

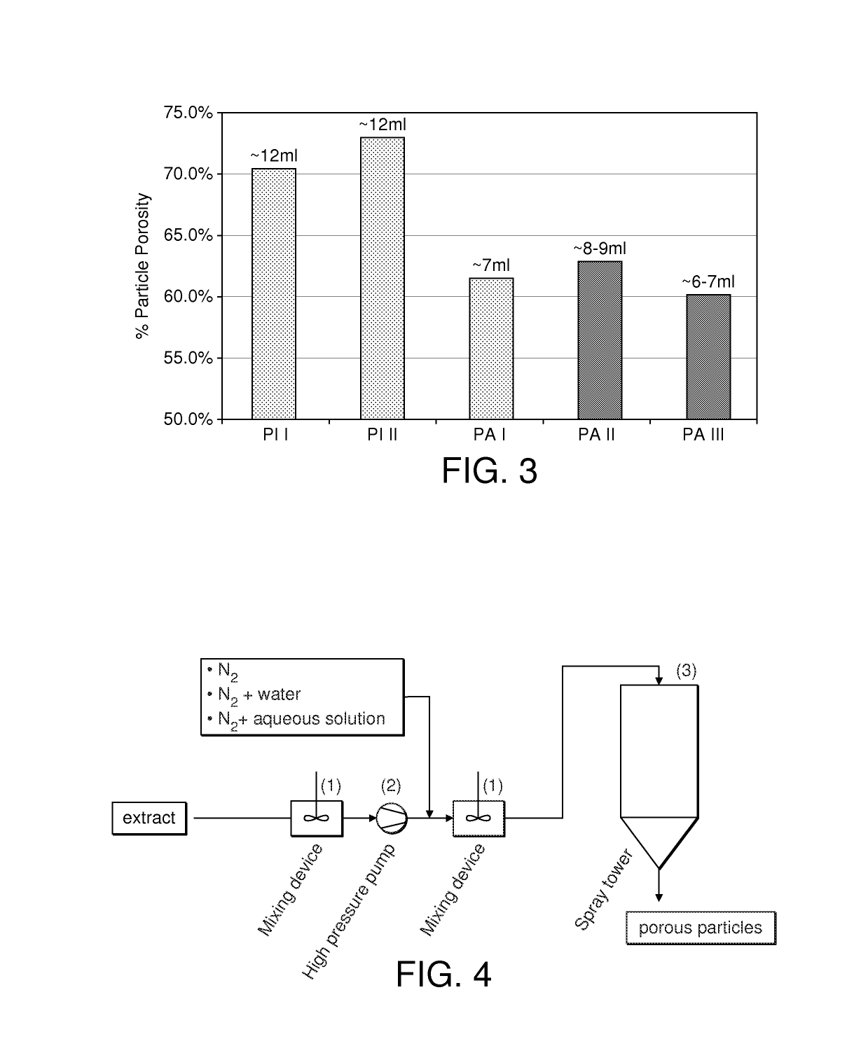

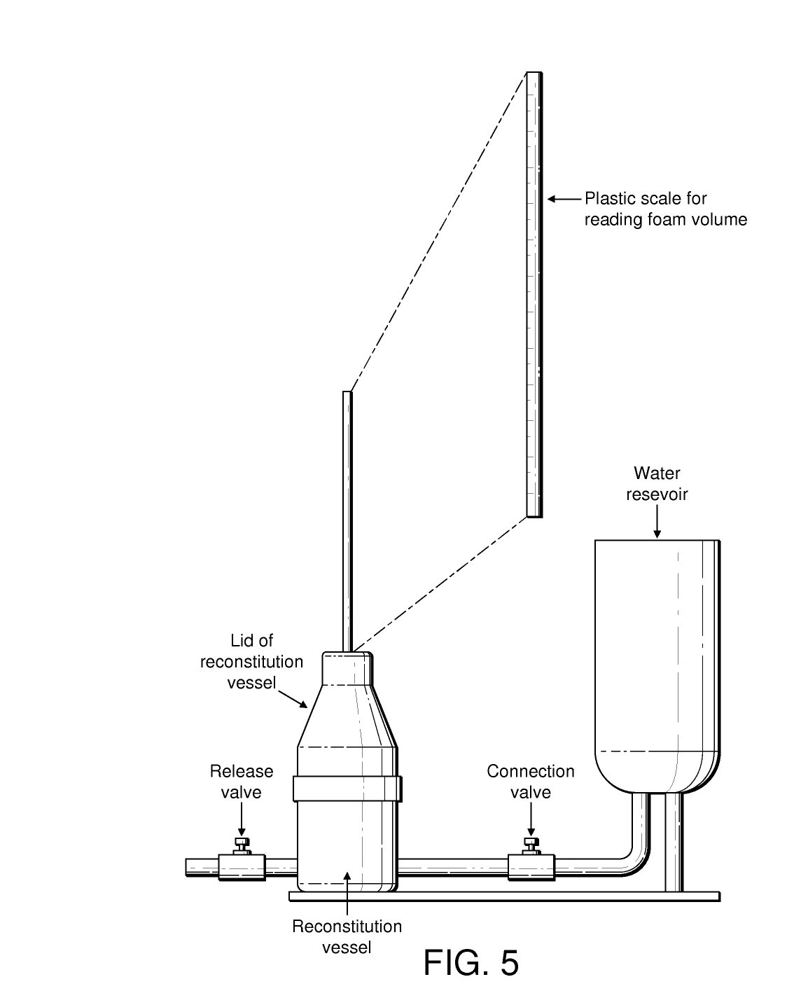

In a first aspect, it has been found that the increased porosity provides an instant beverage with an increased solubility and amount of crema. FIG. 3 shows that all prior art products (PA I, PA II and PA III) which have a lower porosity than the products of the invention (PI I and II) correspondingly produce a lower amount of crema. The amount of crema produced can measured with a simple device (FIG. 5) consisting of a reconstitution vessel connected to a water reservoir, which is initially blocked off with a valve. After reconstituting the instant beverage in the vessel (5 g of powder with 200 ml of deionised water at 85° C. for all results mentioned here), the reconstitution vessel is closed with a special lid that ends in a scaled capillary. The valve between the reconstitution vessel and the water reservoir is then opened and the water (standard tap water of any temperature) pushes the reconstituted beverage upwards into the capillary, thus facilitating the reading of the crema volume.

The prior art products were shown to produce about 6 to 9 mL of crema according to this measurement method, while the product of the invention, upon reconstitution, produced over 10 mL of crema.

It is also thought that a narrow size distribution of the pore size confers stability to the crema which is not observed in prior art products. More surprisingly, it has been found that a combination of the pore size as defined above, with a narrow size distribution and with a high porosity confers to the reconstituted product improved organoleptic properties in terms of texture of the foam, stability and amount.

Although it is not excluded by the present invention, the presence of creamer, lactic proteins, fat, stabilising salts etc. which has been used in many of the products of the prior art to provide a foamy product, is not necessary. A foamy drink may thus be obtained without the use of any additives, by simply modifying the above-mentioned parameters of the powder particles. In one embodiment a beverage powder of the invention comprises a creamer and/or a whitener.

The use of the powder of the invention for the preparation of an instant drink is thus provided. Preferably, the instant drink is coffee. The reconstitution of the powder of the invention in a liquid provides an instant drink having a crema of at least 10 mL (when using 5 g of powder in 200 ml of water). This is a considerable improvement over known products as shown in FIG. 3.

A method to prepare the present instant drink powder is illustrated in FIG. 4. In a first step, an instant drink extract is subjected to high-pressure, typically 50 to 400 bar, preferably 150 to 350 bar. Prior and/or after the high-pressure pump (2), the extract may be mixed in a mixing device (1). The instant drink is thus conveyed to an atomisation nozzle (3) with a high-pressure pump (2). In a preferred embodiment, the extract is a coffee extract having a dry matter content of 35 to 70% at a temperature of 10 to 70° C., preferably 30 to 70° C. It may be advantageous to keep the oil content of the coffee extract low.

Gas is added to the pressurised extract, e.g. in one embodiment between the high-pressure pump (2) and the atomization nozzle (3). In another embodiment gas is added to the extract before the high pressure pump. Typically, the gas is selected from nitrogen, carbon dioxide, nitrous oxide or argon. Preferably it is nitrogen. The quantity of added gas is controlled in such a way that the entire gas is solubilised in the extract. The gas may be added with water or an aqueous solution. Thus, the water or aqueous solution may be saturated or oversaturated with said gas. In that case, the water or aqueous solution is added to the pressurised extract. The water or aqueous solution may further comprise aromas, foam enhancing, foam stabilising components etc. A static mixer or a rotating stirring/mixing device (1) can be used to ensure a constant concentration of the dissolved gas.

The pressurised extract is then sprayed at the atomisation nozzle (3). Due to the rapid pressure drop at the atomisation nozzle, the dissolved gas degasses and forms gas bubbles in the sprayed droplets. The tower temperature during spray drying may e.g. be between 70 and 115° C. The porous structure of the resulting instant drink powder is then solidified by heat (spray-drying).

An instant drink obtainable by the method described above also forms part of the present invention.

The present invention is further illustrated by the following non-limiting example.

### EXAMPLES

Instant drink powders of the invention were produced by:
Extracting a 85% Robusta blend of coffee with standard soluble coffee processing technology, then concentrating the extract to a solid matter content of 45 to 55%.
Heating the extract to a temperature between 50 and 60° C. and pressurising it to between 130 and 160 bar at between 600 and 800 kg/h extract flow rate. Injecting 1-3 (e.g. 1.3 or 2.0) Nl/kg solids of Nitrogen into the pressurised extract at 150 bar leading to solubilisation of the Nitrogen.
Spray-drying the extract at 70-90° C. tower temperature.

### Mercury Porosimeter to Evaluated Particle Porosity

AutoPore IV 9520 was used for the structure evaluation (Micromeritics Inc. Norcrose, Ga., USA). The operation pressure for Hg intrusion was from 0.4 psia to 90 psia (with low pressure from 0.4 psia to 40 psia and high pressure port from 20 to 90 pisa). The pore diameter under this pressure ranged from 500 to 2 um.

About 0.1 to 0.4 g of samples was precisely weighted and packed in a penetrometer (volume 3.5 ml, neck or capillary stem diameter 0.3 mm and stem volume of 0.5 ml).

After the penetrometer inserted to the lower pressure port, sample was evacuated at 1.1 psia/min, then switch to a medium rate at 0.5 pisa and a fast rate at 900 μm Hg. The Evacuating target is 60 μm Hg. After reaching the target, the evacuation was continued for 5 min before Hg was filled in.

The measurement was conducted in set-time equilibration. That, is, the pressure points at which data are to be taken and the elapsed time at that pressure in the set-time equilibration (10 sec) mode. Roughly 140 data points were collected at the pressure ranges.

The bulk volume of the sample is obtained from the initial volume of mercury and the sample holder. The volume of the inter particle voids is obtained after intrusion with mercury up to 2 μm. Subtraction of the inter particle voids from the bulk volume of the sample gives the volume of the particles. The volume of the void space in the particle is obtained by subtracting the volume of the coffee matrix from the volume of the particles. The volume of the coffee matrix is obtained from the weight of the sample and coffee matrix density. The particle porosity is the ratio of voids volume in the particle to that of the volume of the particle.

### Determination of the Internal Structure of Coffee Particles by Microcomputed X-ray Tomography and 3D Image Analysis

### Images Acquisition

X-ray tomography scans were performed with a 1172 Skyscan MCT (Antwerpen, Belgium) with a X-ray beam of 80 KV and 100 uA. Scans were performed with the Skyscan software (version 1.5 (build 0) A (Hamamatsu 10 Mp camera), reconstruction with the Skyscan recon software (version 1.4.4).

Coffee particles were scanned in a polystyrene tube (1.6 mm diameter, 2 mm height, or a sticky tape (maximum 4 mm diameter) was covered by a layer of coffee particles and scanned. For a pixel size of lum, the camera was set up at 4000×2096 pixels and placed in the Far position. Exposure time was 2356 ms. Scan was performed over 180°, the rotation step was 0.3° and the frame averaging was 4.

The reconstruction of the dataset was performed over 400 slices in average, with the settings contrast at 0.008-0.22. Smoothing and ring artefact reduction were set up at 1 and 5, respectively.

### 3D Analysis of the Images

3D image analysis was performed on the 1 um per pixel datasets with CTAn software (version 1.7.0.3, 64-bit). The analysis was performed in two steps: (i) a first step to select the particles to be analysed by excluding the inter particles voids, (ii) the second step to obtain the distribution of the porosity of the particles. The particle porosity value obtained by this technique matches closely the mercury porosimetry.

(i) Selection of the particles, i.e. volume of interest:

The images of lum per pixel resolution in grey levels (255 grey levels) were segmented at a grey level of 30, cleaned by removing any single spots smaller than 16 pixels, and then dilated by mathematical morphology (radius of 3 pixels). The selection of the volume of interest was performed through the shrink-wrap function, and then this volume was eroded by mathematical morphology (radius of 3 pixels) to adjust to the surface of the particles.

(ii) Void space distribution in the particles:

The images in grey levels were reloaded and segmented at a grey level of 40. The particles porosity was then calculated as the ratio of the volume of pores out of the particles volume, the particles volume being equal to the volume of interest defined above (i). The structure separation gave the particles pores size distribution.

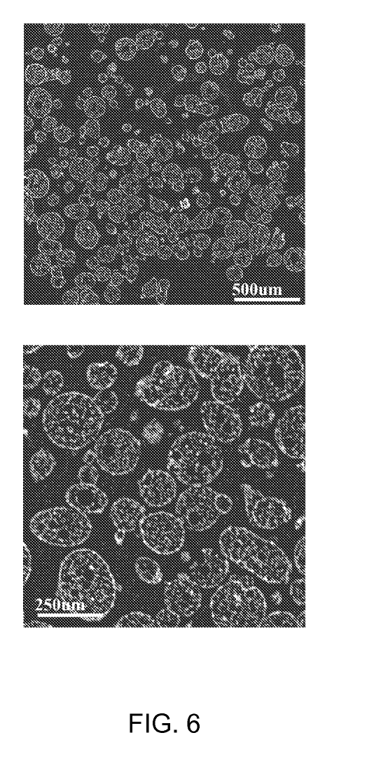

Beverage powders were produced by the method described above and characterised by the methods described above. The results are given in FIGS. 1, 2 and 3, wherein PI I and PI II are beverage powders of the invention produced from coffee extract, and PA I, PA II and PA III, are beverage powders produced from coffee extract by prior art methods. PA II and PA III are commercial soluble coffee powders marketed as providing an espresso beverage with good crema. FIG. 6 show typical examples of the structure of coffee beverage particles of the invention.

1. Instant drink powder comprising porous powder particles, the powder particles comprising a porosity of at least 55%.

2. Powder according to claim 1, wherein the powder particles comprise pores having an average diameter D₅₀ of less than 80 microns.

3. Powder according to claim 1, wherein the pores have a size distribution having a distribution span factor of less than 4.

4. Powder according to claim 1, wherein the powder particle porosity is between 65 and 85%.

5. Powder according to claim 1, wherein the powder particles have pores comprising an average diameter D₅₀ value of between 10 and 80 microns.

6. Powder according to claim 1, wherein the instant drink is selected from the group consisting of a coffee and a coffee/chicory mixture.

7. Powder according to claim 1, comprising a creamer and/or whitener.

8. A method of preparing a drink comprising the step of using a powder comprising porous powder particles having a porosity of at least 55%.

9. Method according to claim 6, wherein the instant drink has a crema of at least 10 mL when using 5 g of powder in 200 ml of 85° C. deionized water.

10. Method according to claim 6, wherein the instant drink is coffee.

11. Method for manufacturing an instant drink powder comprising the steps of:
subjecting an instant drink extract to a pressure of 50 to 400 bar,
adding gas to a pressurised extract; and
spraying and drying a resultant extract to form an instant drink powder.

12. Method according to claim 9, wherein the instant drink is selected from the group consisting of a coffee and a coffee/chicory mixture.

13. Method according to claim 9, wherein the gas is selected from the group consisting of nitrogen, carbon dioxide, and nitrous oxide.

14. Method according to claim 9, wherein the gas is added with water or an aqueous solution.

15. Method according to claim 9, comprising a component selected from the group consisting of aromas, foam enhancing, and foam stabilising components.

16. Method according to claim 9, wherein the water or aqueous solution is saturated or oversaturated with gas.

17. Method according to claim 9, wherein the drying is spray-drying.

18. Instant drink powder comprising a porous powder having a porosity of at least 65% and a crema of at least 10 mL when using 5 g of powder in 200 ml of 85° C. deionized water.

19. Powder according to claim 1, wherein the powder particles have a porosity of at least 70%.

20. Powder according to claim 1, wherein the powder particles comprise pores having an average diameter D₅₀ less than 25 microns.

21. Powder according to claim 1, wherein the pores have a size distribution having a distribution span factor of less than 1.5.

22. Powder according to claim 1, wherein the powder particle porosity is between 70 and 75%.

23. Powder according to claim 1, wherein the powder particles have pores having an average diameter D₅₀ value of between 10 and 25 microns.
